(19) United States
(12) Patent Application Publication
(10) Pub. No.: US 2006/0093179 A1
(43) Pub. Date: May 4, 2006

(54) Electro-acoustic audio transducer

(76) Inventors: Michael J. Desimone, Redmond, WA (US); David J. Brown, Enumclaw, WA (US)

Correspondence Address: LAW OFFICES OF RONALD M ANDERSON, 600 108TH AVE, NE, SUITE 507, BELLEVUE, WA, 98004, US

(21) Appl. No.: 11/248,654

(22) Filed: Oct. 12, 2005

Related U.S. Application Data
(60) Provisional application No. 60/619,386, filed on Oct. 15, 2004.

(51) Int. Cl. H04R 9/06

(52) U.S. Cl. 381/400

(57) ABSTRACT

A dynamic transducer having a voice coil attached to and suspended between two diaphragms that comprise two opposite sides of an enclosure. The voice coil is suspended within the enclosure on a center support that passes through the enclosure and is attached to the diaphragms. Within the enclosure, an annular magnet having a hollow cylindrical ferromagnetic core is disposed between two annular ferromagnetic plates and is attached to one of the plates. A narrow gap is formed within the magnetic structure. The voice coil travels within the gap and is attached to a non-ferromagnetic shaft that extends through the hollow cylindrical ferromagnetic core. The voice coil is fastened to the diaphragm comprising each side of the housing, so that the diaphragms move to produce audible sound. An internal fusing mechanism is directly attached to the voice coil to protect the coil against thermal and electrical overload.

### RELATED APPLICATIONS

This application is based on a prior copending provisional application, Ser. No. 60/619,386, filed on Oct. 15, 2004, the benefit of the filing date of which is hereby claimed under 35 U.S.C. § 119(e).

### BACKGROUND

This disclosure generally pertains to an audio transducer, and more specifically, to an audio transducer that can be mounted to a structure to transfer acoustic energy and motion to the structure to produce audible sound proximate the structure as the structure is driven into vibration in the audible frequency range.

There are a number of acoustic transducers on the market, which are used for driving structures such as walls, seats, or other types of environmental structures, with acoustic energy in order to provide either a surround sound or virtual reality effect, and which are often used for this purpose in connection with the sound produced as part of video games that are played, or in connection with movies being viewed in home theaters. Also, a number of products exist in the prior art that include innovations in this area of technology.

However, the devices currently on the market generally have a limited frequency range and are designed for specific applications. In addition, their mechanical properties and hence, their frequency response may be largely determined by the structure to which they are mounted and the mounting device itself. Therefore, there is interest in the market in methods and apparatuses that address these and other limitations of the art.

### SUMMARY

One implementation described in more detail below includes an audio transducer. Briefly, the audio transducer generally includes a transducer enclosure. A mounting shaft that includes a central orifice is described below as being fixed within the transducer enclosure. A magnetic circuit is also described as being fixed within the transducer enclosure, but fixed independent of the mounting shaft. A voice coil is described as being fixed to the mounting shaft within the transducer enclosure, and positioned proximate to the magnetic circuit such that a modulated current signal applied to the voice coil will interact with the magnetic field of the magnetic circuit causing the magnetic circuit to deflect in relation to the mounting shaft. As described below, the deflection of the mounting shaft causes the transducer enclosure to deflect in proportion to the applied modulated current signal, which produces an audio sound output from the transducer enclosure.

Another aspect is directed to a method for generating an acoustic output with a transducer housing. The method includes the steps of coupling a magnetic circuit to a first portion of the transducer housing, and coupling a voice coil to a second portion of the transducer housing. The method also includes the step of providing the voice coil with a modulated current signal to cause the magnetic circuit to deflect in relation to the voice coil and thereby cause the transducer housing to deflect proportionally to the applied modulated current signal, generating the acoustic output with the transducer housing.

Yet another aspect, which is described in detail below, is directed to an audio transducer assembly for coupling mechanical energy to a structure. The assembly includes an audio transducer having a voice coil suspended between two diaphragms that in part form a transducer enclosure. A magnet structure operable to generate mechanical energy in conjunction with the voice coil can be suspended around the voice coil by attachment to a flexible surface, the flexible surface coupling the two diaphragms and in part, defining the transducer enclosure. An apparatus for mechanically coupling the transducer to a structure is also described. The apparatus can be configured to substantially couple mechanical energy generated by the transducer when the voice coil is driven with an audio modulated current signal.

The transducer described in detail below is intended to provide the flexibility to enable simple tuning of frequency response within a wide frequency range, scalability for various power output ranges, and a structurally robust mounting that allows a variety of mounting options and positions. The transducer can also include an internal protection device sized for the particular design of the transducer, to provide optimum protection, performance, and environmental robustness. The transducer in one or more embodiments is fully enclosed and easily waterproofed merely by using sealants in the assembly of its case. A common voice coil can be used to provide simplicity, along with good audio properties.

This Summary has been provided to introduce a few concepts in a simplified form that are further described in detail below in the Description. However, this Summary is not intended to identify key or essential features of the claimed subject matter, nor is it intended to be used as an aid in determining the scope of the claimed subject matter.

### DRAWINGS

Various aspects and attendant advantages of one or more exemplary embodiments and modifications thereto will become more readily appreciated as the same becomes better understood by reference to the following detailed description, when taken in conjunction with the accompanying drawings, wherein:

FIG. 1 is a front elevational view of an embodiment of an audio transducer;

FIG. 2 is a side elevational view of the embodiment of FIG. 1; and

FIG. 3 is a side cross-sectional view of a transducer assembly mounted to a structure, taken through a central axis along a section line 10-10 in FIG. 2.

### DESCRIPTION

Figures and Disclosed Embodiments Are Not Limiting

Exemplary embodiments are illustrated in referenced Figures of the drawings. It is intended that the embodiments and Figures disclosed herein are to be considered illustrative rather than restrictive.

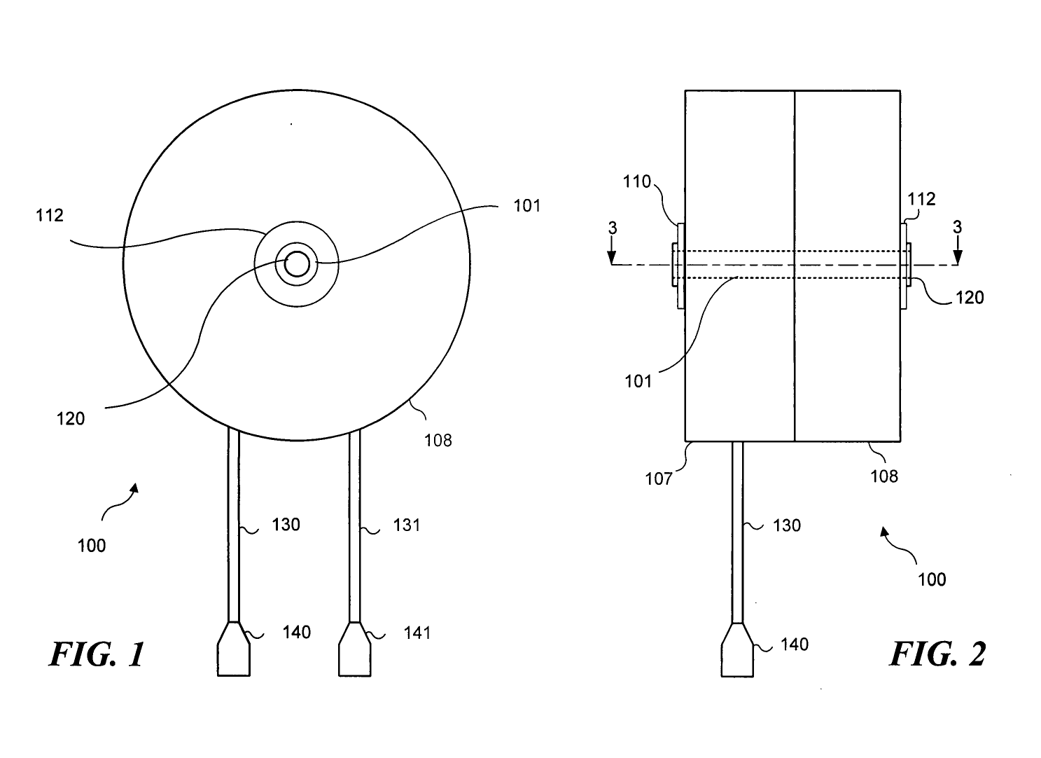

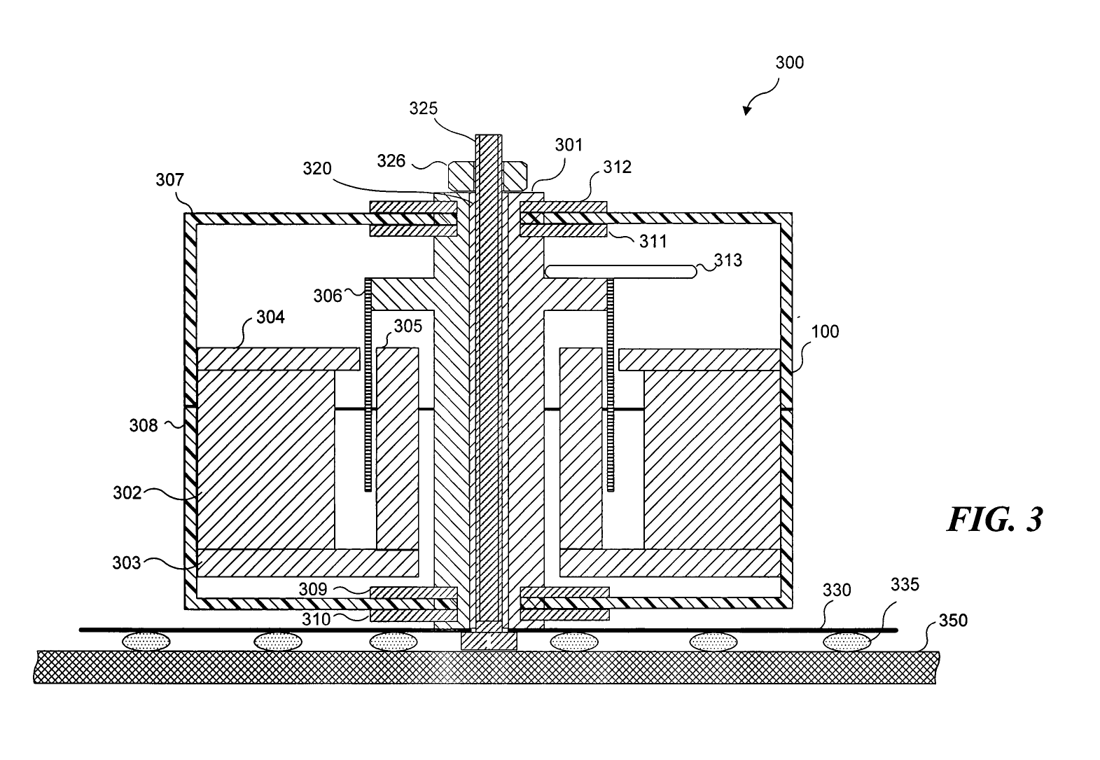

FIGS. 1 and 2 respectively show front and side views of an audio transducer, in accord with one exemplary implementation. The audio transducer 100 is generally cylindrical in shape, with a pair of leads 130 and 131 having spade terminals 140 and 141 extending from one edge of a transducer enclosure comprising two enclosure halves 107 and 108, for attachment to an external audio signal source (not shown). Transducer 100 can be mounted either by means of a fastener that extends through a central orifice 120, or by a clamp (not shown) fastened around the circumference of the enclosure. A preferred method of attachment is by means of a bolt (not shown) or other fastener that extends through central orifice 120 to rigidly clamp the transducer to a mounting plate. The mounting plate can then be adhered to the driven surface using an epoxy or other suitable adhesive, as discussed below with reference to FIG. 3.

Enclosure halves 107 and 108 can be fabricated of any suitable material, such as polypropylene, polyvinylchloride, fiberglass composite, graphite composite, various polymers, cellulose composites such as wood and cardboard products; and various metals and alloys, such as aluminum and steel. Generally, the material properties of enclosure halves 107 and 108 will in part determine the audio properties of the transducer, and as such, the material used to fabricated the enclosure will be selected in order to implement predetermined objective audio performance metrics, such as frequency response and sound pressure level, as well as other parameters, such as durability and weather resistance. In one example, enclosure halves 107 and 108 are composed of polypropylene, and each half has a diameter of about 3.75 inches and a depth such that when coupled together, the halves form an enclosure of about 1.75 inches.

FIG. 3 shows a cross-sectional view of a transducer assembly 300 mounted to a structure 350. The exemplary transducer 100 illustrated in FIGS. 1 and 2 is depicted split along a section line through the central axis, in order to illustrate its internal components. The components can be attached to one another with a suitable adhesive. As illustrated in FIG. 3 hollow mounting shaft 301 includes a supporting surface for washers 309 and 311 and can be crimped to provide an additional mechanical grip on enclosure halves 307 and 308 via washers 310 and 312 (as used herein, the term “enclosure” is interchangeable with the terms “housing” and “case”). A fastener that in one implementation includes a bolt 325 and a nut 326, a mounting plate 330, and epoxy form a transducer fastening assembly for affixing transducer 100 to a driven structure 350 to produce audio output in the form of sound that is readily audible to a user.

Mounting shaft 301 serves to attach a voice coil 306 to case halves 307 and 308 using metal washers 309, 310, 311, and 312, which are used to clamp transducer housing 301 to mounting shaft 301 in a fixed position as illustrated in FIG. 3. The material of the washers, their diameter, thickness, and softness, as well as the diameter and depth of enclosure halves 307 and 308 can all be independently changed to alter the frequency characteristics of the transducer. The sides of the housing formed by enclosure halves 307 and 308 provide the flexure required for the mechanical vibration of the transducer. In one exemplary implementation, enclosure halves 307 and 308 are affixed together with a suitable flexible adhesive to form a sealed flexible transducer housing. Mounting shaft 301 can be formed of any suitable non-ferromagnetic material. In one specific example, mounting shaft 301 is aluminum and is sized to fit within a central orifice diameter of about 0.25 inches.

A magnetic field is established by an annular ring magnet 302 and directed from one pole of magnet 302 by an annular plate 304 and from another pole of magnet 302 by another annular plate 303. An annular core 305 concentrates the magnetic field in the annular air gap where voice coil 306 travels in order to provide a force against which an induced current in voice coil 306 can react. These components generally serve as a magnetic circuit within transducer 100 and can be fabricated of materials such as ferromagnetic steel, a rare earth element alloy, an aluminum-nickel-cobalt alloy, or a ceramic magnetic material.

In operation, a varying magnetic current applied to voice coil 306 interacts with the magnetic field produced by the magnetic circuit to provide an axial force on the coil. This force is transferred to mounting shaft 301 as an axial force and then, to fastener pair 325 and 326, and to plate 330, which is affixed to the driven structure with an epoxy 335. The axial force reacting against magnet 302, annular plates 303 and 304, and core 305 causes a time varying deflection of the magnetic circuit and consequently, the housing to which the magnetic circuit is directly attached. The deflection of the housing comprises the sound energy that is transferred to structure 350 to which the transducer assembly 300 is mounted, so that the sound energy becomes audible due to the vibration of the structure.

It should be noted at this point that the characteristics of mounting plate 330 can alter characteristics of the sound output significantly, for example, in regard to volume and frequency range. In one implementation, a carriage bolt 325 extends through a semi-flexible aluminum disc 330 (e.g., formed to be about a 0.025″ thick). Disc 330 can then be affixed to structure 350 or another surface with epoxy 335 so that the tip of carriage bolt 325 head alone is directly against structure 350, as illustrated in FIG. 3. This particular mounting technique deviates from a more conventional cantilever structure of other conventional voice coil transducer designs and provides greater design flexibility and desirable mechanical properties by not requiring the rigidity of a cantilever structure.

In one implementation, magnet 302 and annular plates 303 and 304 are adhered securely in a fixed position to case halves 307 and 308, around their circumference. When transducer 100 is attached to a solid surface (e.g., to structure 350) by a fastener 325 and 326 through mounting shaft 301, the magnetic circuit moves back and forth along its axis as the faces of the case halves (307 and 308) flex. Since mounting shaft 301 is mounted on either end of transducer 100, all motion is constrained to be in the axial direction (i.e., along the longitudinal axis of mounting shaft 301). This configuration allows for a very flexible case member, thereby enabling output of a relatively high level of audio energy over a broad frequency range.

In one implementation, a fusing device 313 is attached directly to mounting shaft 301 and is electrically attached in series with voice coil 306 to protect the coil from excessive current that might damage the coil. In an example, fusing device 313 is a resettable polyfuse device that opens when electrical current greater than a predefined level flow through the fusing device, which cause the temperature of the device to rise sufficiently so that it tips and produces an open circuit condition. Mounting a resettable polyfuse device directly to voice coil 306 in this manner ensures that it is exposed to the temperature of voice coil 306 and provides consistent thermal tracking and over-current protection. Attachment of fusing device 313 directly to voice coil 306 enables very accurate protection of the voice coil, because fusing device 313 is less subject to external temperature or other environmental variations and more directly effected by the temperature of the voice coil. This implementation further allows for a fully enclosed transducer enclosure that is easily sealed to be waterproof.

Transducer 100 is intended to be mounted to a structure 350 by fastener 325 that passes through the center of generally non-ferromagnetic mounting shaft 301 to which voice coil 306 is attached. Transducer 100 will thus excite the structure 350 with mechanical sound energy as transducer 100 is activated with the varying drive electrical current. Transducer 100 can also be mounted to structure 350 by an attachment to its edge to provide a dual cone speaker (not shown). The dual cone speaker embodiment can be realized using a standard voice coil and other conventional parts for the diaphragm. It may be scaled in size, mass, spring constant, and damping merely by selection of appropriate materials, and scaling of the components.

Although the presently disclosed embodiments have been described in connection with the preferred form of practicing them and any modifications thereto, those of ordinary skill in the art will understand that many other modifications can be made to the embodiments described herein that are within the scope of the claims that follow. Accordingly, it is not intended that the scope of what is described in the embodiments above in any way be limited by the above description, but instead be determined entirely by reference to the claims that follow.

The invention in which an exclusive right is claimed is defined by the following:

1. An audio transducer, comprising:
(a) a transducer enclosure;
(b) a mounting shaft defined in part by a central orifice and fixedly disposed substantially within and passing through the transducer enclosure;
(c) a magnetic circuit fixedly disposed within the transducer enclosure and mechanically independent of the mounting shaft;
(d) a voice coil affixed to the mounting shaft within the transducer enclosure, the voice coil being disposed proximate to the magnetic circuit such that a varying electrical current signal applied to the voice coil interacts with the a magnetic field produced by the magnetic circuit causing the magnetic circuit to deflect in relation to the mounting shaft and thereby causing the transducer enclosure to deflect in proportion to the applied varying electrical current signal to produce an audible sound output from at least a portion of the transducer enclosure as a result of the movement of the transducer enclosure relative to the voice coil.

2. The audio transducer of claim 1, and further comprising a voice coil protection circuit in electrical communication with the voice coil, the voice coil protection circuit being disposed within the transducer enclosure.

3. The audio transducer of claim 1, wherein the transducer enclosure is defined by a first enclosure half and a second enclosure half, the first enclosure half being defined in part by a first outer surface and a first inner surface, the second half being defined in part by a second outer surface, and a second inner surface.

4. The audio transducer of claim 3, wherein the first enclosure half and the second enclosure half each comprise a material selected for predetermined audio transducing properties.

5. The audio transducer of claim 4, wherein the first and second enclosure halves comprise at least one of:
(a) polypropylene;
(b) polyvinylchloride;
(c) a fiberglass composite;
(d) graphite composite
(e) a polymer;
(f) a cellulose composite; and
(g) aluminum.

6. The audio transducer of claim 3, wherein at least one physical dimension of the first and second enclosure halves is selected to achieve predetermined audio transducing properties of the transducer enclosure.

7. The audio transducer of claim 3, wherein the first and second enclosure halves each define first and second portions of a separable, substantially cylindrical, substantially hollow transducer enclosure body.

8. The audio transducer of claim 7, wherein the first and second portions are coupled together with a flexible adhesive.

9. The audio transducer of claim 3, further comprising a plurality of washers disposed about the mounting shaft proximate the first and second outer surfaces and first and second inner surfaces of the transducer enclosure.

10. The audio transducer of claim 9, wherein each of the plurality of washers is selected to achieve predetermined audio transducing properties of the transducer enclosure based on at least one of:
(a) washer dimensions;
(b) washer material composition; and
(c) washer material properties.

11. The audio transducer of claim 1, wherein the magnetic circuit comprises:
(a) an annular ring magnet;
(b) a first annular plate affixed to a first pole of the annular ring magnet;
(c) a second annular plate affixed to a second pole of the annular ring magnet; and
(d) an annular core affixed to the second annular plate and disposed proximate to the first annular plate to form a magnetic gap.

12. The audio transducer of claim 8, wherein the magnetic circuit comprises at least one of:
(a) ferromagnetic steel;
(b) a rare earth element alloy;
(c) an aluminum-nickel-cobalt alloy; and
(c) a ceramic magnetic material.

13. The audio transducer of claim 1, wherein the mounting shaft is formed of a substantially non-ferromagnetic material.

14. The audio transducer of claim 1 and further comprising a plurality of output connectors in electrical communication with the voice coil, the plurality of output connectors being configured to couple the varying electrical current signal to the voice coil from an audio signal electrical current source that is external to the transducer enclosure.

15. The audio transducer of claim 1, and further comprising a fastening assembly for acoustically coupling the transducer to a structure.

16. The audio transducer of claim 15, wherein the fastening assembly comprises:
(a) a mounting plate;
(b) a fastener for substantially rigidly coupling the mounting plate to the transducer enclosure through the central orifice of the mounting shaft; and
(c) an adhesive for adherently affixing the plate to a structure to be driven by the audio transducer.

17. A method for generating an acoustic audible output with a transducer housing, comprising the steps of:
(a) coupling a magnetic circuit to a first portion of the transducer housing;
(b) coupling a voice coil to a second portion of the transducer housing; and
(c) energizing the voice coil with a varying electrical current signal to cause the magnetic circuit to deflect in relation to the voice coil and thereby cause the transducer housing to deflect proportionally to the applied varying electrical current signal, so as to generate the acoustic audible output with the transducer housing.

18. The method of claim 17, further comprising the step of coupling the transducer housing to a surface.

19. The method of claim 18, further comprising the step of constraining the deflection of the transducer housing relative to a mechanical coupling to the surface, in order to increase a magnitude of acoustic output energy conveyed to the surface by the transducer.

20. An audio transducer assembly for coupling mechanical energy to a structure, comprising:
(a) an audio transducer having a voice coil suspended between two diaphragms that in part form a transducer enclosure;
(b) a magnet structure operable to generate a varying force in cooperation with the voice coil when the voice coil is energized with an audio electrical current signal, the magnetic structure being suspended around the voice coil by an attachment to an adjacent flexible surface, the flexible surface coupling the two diaphragms and in part defining the transducer enclosure; and
(c) means for mechanically coupling the transducer to a structure, wherein the means are configured to substantially couple acoustical energy generated by the transducer into the structure when the voice coil is driven with the audio electrical current signal.
